(19) United States
(12) Patent Application Publication
(10) Pub. No.: US 2008/0193495 A1
(43) Pub. Date: Aug. 14, 2008

(54) DISPOSABLE HAND SANITIZER GEL DISPENSER

(76) Inventor: MARYAM YOUSEFI KHARAZMI, Yorba Linda, CA (US)

Correspondence Address: VLADIMIR KHITERER;KHITERER LAW OFFICE, 2109 W. COAST HWY., SUITE 200, NEWPORT BEACH, CA, 92663, US

(21) Appl. No.: 11/674,770

(22) Filed: Feb. 14, 2007

(51) Int. Cl. A01N 25/34; A01P 1/00

(52) U.S. Cl. 424/404; 424/402

(57) ABSTRACT

A disposable hand sanitizer gel dispenser is disclosed. It comprises a base with two straps for releasably adhering to one another for wrapping around a wrist of a user and a plurality of pouches filled with sanitizer gel disposed along the length of the base.

### FIELD OF THE INVENTION

The present invention relates to a disposable hand sanitizer gel dispenser.

### BACKGROUND OF THE INVENTION

Using an alcohol-based hand sanitizer gel significantly reduces the spread of gastrointestinal infections. Hand sanitizer gels are often used as a substitute for hand washing when hand washing facilities are not available. The main ingredients of hand sanitizers are either ethanol or isopropanol, or a combination of these two products. Many hand sanitizers also contain a moisturizer to minimize irritation to the skin. Alcohol gel, in essence, strips away the outer layer of oil on the skin destroying microbes present on the surface of the hands.

Conventionally, hand sanitizer gels are dispensed from plastic containers, like many other personal care products. The disadvantages of using plastic containers for hand sanitizer gels includes drying out and evaporation due to the alcohol content, inconvenience of carrying the containers around, difficulty in coaxing small children to carry and use correct amounts of hand sanitizer gels. Accordingly, there is need for a hand sanitizer gel dispenser that overcomes these disadvantages.

### SUMMARY OF THE INVENTION

The disposable hand sanitizer gel dispenser according to this invention satisfies this need. Specifically, it comprises a base with two straps for releasably adhering to one another and a plurality of pouches filled with sanitizer gel disposed along the length of the base.

The disposable hand sanitizer gel dispenser according to this invention can be wrapped around a wrist of a user or easily attached to a number of objects, including key chains, handbags and the like and carried around. After use of the gel from all pouches, the dispenser is disposed of.

### BRIEF DESCRIPTION OF THE DRAWINGS

FIG. 1 is a perspective view of the disposable hand sanitizer gel dispenser according to this invention;

FIG. 2 is a top plan view of a portion thereof;

FIG. 3 shows the use thereof.

### DETAILED DESCRIPTION

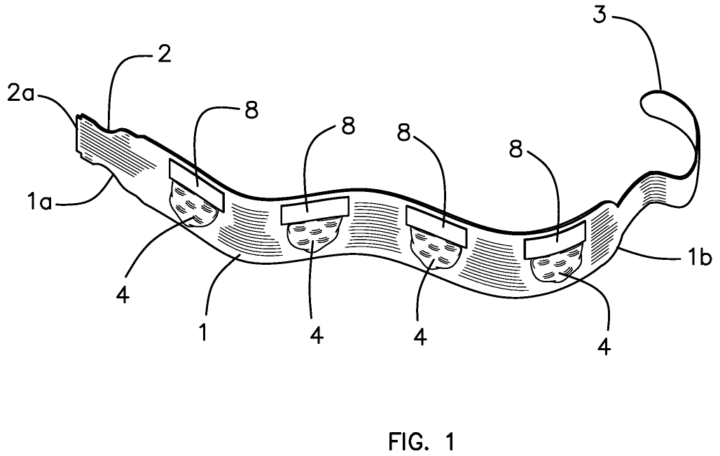

This invention will be better understood with the reference to the drawing figures FIG. 1 through FIG. 3. The same numerals refer to the same elements in all drawings figures.

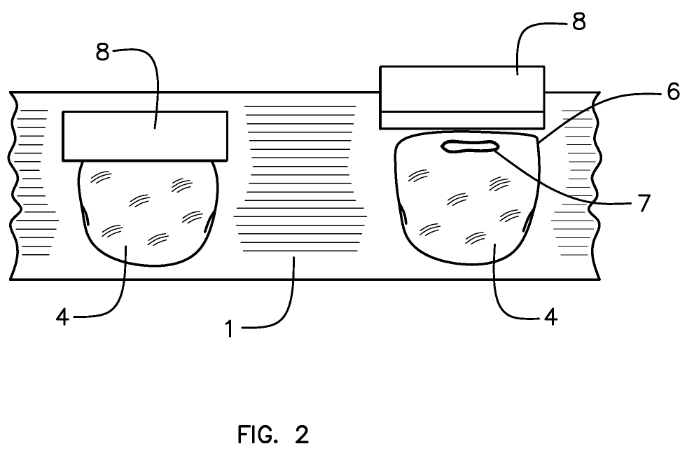

Viewing now, simultaneously, FIGS. 1 and 2, numeral 1 indicates a base. Base 1 is ribbon shaped and comprises a proximate end indicated by numeral 1a and a distal end indicated by numeral 1b.

Numeral 2 indicates a first strap. First strap 2 is disposed on proximate end 1a and comprises a tip coated with a resealable adhesive indicated by numeral 2a.

Numeral 3 indicates a second strap. Second strap 3 is disposed on distal end 1b for releasably adhering to tip 2a.

Numeral 4 indicates a pouch. A plurality of pouches 4 are disposed on base 1, one pouch 4 succeeding another pouch 4 along the length of base 1.

Each pouch 4 comprises a predetermined quantity of hand sanitizer gel. As the persons most knowledgeable in the pertinent arts will recognize, filling pouches 4 with a predetermined quantity of hand sanitizer gel can be accomplished by way of automated form-filled seal equipment.

Each pouch 4 also comprises a top indicated by numeral 6 and an opening in top 6 indicated by numeral 7 for squeezably releasing the hand sanitizer gel through opening 7. A user would press on pouch 4 causing the hand sanitizer gel to be squeezed through opening 7.

Numeral 8 indicates a resealable flap. Resealable flap 8 is positioned on top 6 and dimensioned to cover opening 7. Resealable flap 8 can be placed in an open position when the user pulls it up, permitting release of the hand sanitizer gel through opening 7. In a sealed position, resealable flap 8 prevents release of the hand sanitizer gel through opening 7.

In this preferred embodiment, base 1, first strap 2 and second strap 3 are shown to be made out of a unitary piece of stretch resistant material, such as a fine high density polyethylene fiber material known as “Tyvek” manufactured by DuPont Corporation or a number of plastic materials known to the persons knowledgeable in the pertinent arts.

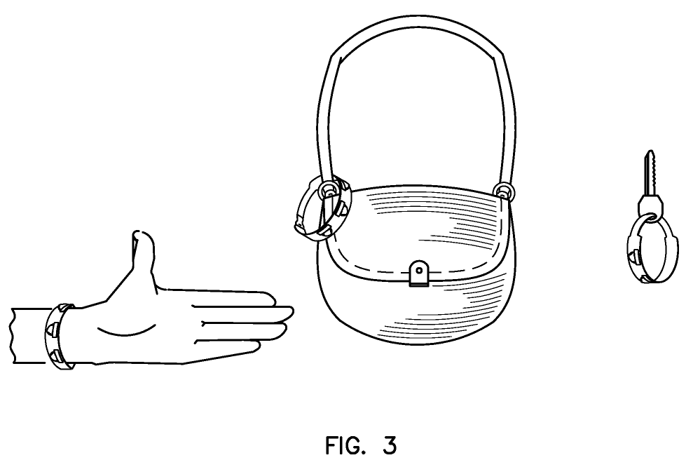

Viewing now FIG. 3, base 1 is adapted for wrapping around a wrist of the user and is shown in FIG. 3 as fitting snugly around a wrist of the user. This permits wearing the hand sanitizer gel dispenser for extended periods of time without discomfort.

Alternatively, the disposable hand sanitizer gel dispenser according to this invention can be easily attached to a number of objects, including key chains, handbags and the like and carried around. After use of the gel from all pouches 4, the dispenser is disposed of.

What is claimed is:

1. A disposable hand sanitizer gel dispenser comprising:
(a) a ribbon shaped based comprising a proximate end and a distal end;
(b) a first strap disposed on the proximate end, comprising a tip coated with a resealable adhesive;
(c) a second strap disposed on the distal end for releasably adhering to the tip;
(d) a plurality of pouches disposed on the base, one pouch succeeding another pouch along the length of the base, each pouch comprising:
a predetermined quantity of hand sanitizer gel;
a top and an opening in the top for squeezably releasing the hand sanitizer gel through the opening;
a resealable flap positioned on the top and dimensioned to cover the opening, such that the resealable flap can be placed in an open position permitting release of the hand sanitizer gel through the opening and a sealed position preventing release of the hand sanitizer gel through the opening.

2. A disposable hand sanitizer gel dispenser as in claim 1, wherein the base, first strap and second strap are made out of a unitary piece of stretch resistant material.

3. A disposable hand sanitizer gel dispenser as in claim 2, wherein the base is adapted for wrapping around a wrist of a user.

4. A disposable hand sanitizer gel dispenser as in claim 3, wherein the base fits snugly around a wrist of the user.
